(19) United States
(12) Patent Application Publication
(10) Pub. No.: US 2015/0123853 A1
(43) Pub. Date: May 7, 2015

(54) WIRELESS TRANSCEIVER DEVICE AND ANTENNA MODULE THEREOF

(71) Applicant: Lynwave Technology Ltd., New Taipei (TW)

(72) Inventor: San-Yuan WU, New Taipei (TW)

(21) Appl. No.: 14/534,945

(22) Filed: Nov. 6, 2014

(30) Foreign Application Priority Data
Nov. 6, 2013 (TW) 102140332

(51) Int. Cl. H01Q 9/04

(52) U.S. Cl. CPC H01Q 9/04
USPC 343/700 MS

(57) ABSTRACT

A wireless transceiver device and an antenna module thereof, the antenna module has the current path of a first resonance frequency band and the current path of a second resonance frequency band. The first resonance frequency band partially overlaps the second resonance frequency band. Therefore, the antenna module has a larger working frequency band, and forms the single band antenna integrally.

### CROSS-REFERENCE TO RELATED APPLICATIONS

This non-provisional application claims priority under 35 U.S.C. §119(a) on Patent Application No. 102140332 filed in Taiwan, R.O.C on Nov. 6, 2013, the entire contents of which are hereby incorporated by reference.

### BACKGROUND OF THE INVENTION

1. Technical Field of the Invention

The present invention relates to a wireless transceiver device and an antenna module thereof, particularly to a single band wireless transceiver device and an antenna module thereof.

2. Description of the Related Art

In recent years, because the popularity of laptops, smart phones, tablet computers, and other consumer electronics products, people can exchange information between different regions in the world with each other, so that the communication is evolved from the early wired network to the current coexistence of wireless and wired network.

In response to the demand of wireless networks, computers need to be electrically connected with wireless transceivers, so that the computers can successfully transmit and receive wireless signals. Currently, common wireless transceivers usually follow the universal serial bus (USB) standard, such as USB dongle, in order to connect to the USB port of a computer.

At least one antenna module is installed inside the wireless transceiver for transmitting and receiving wireless signals. Currently, conventional types of the antenna module can be roughly classified to monopole antenna and dipole antenna, and only a few operate in multi-bands.

In order to utilize the space usage and the storage convenience when carrying, the wireless transceiver is gradually designed towards a smaller and smaller scale. However, since the size of the wireless transceiver is restricted, it results in the difficulty of impedance matching, and inevitably limits the bandwidth and efficiency.

### SUMMARY OF THE INVENTION

Owing to the aforementioned problem, the present invention provides a wireless transceiver device and an antenna module thereof and the integrally formed antenna structure applied to the wireless transceiver device has a larger working frequency band.

According to an antenna module of an embodiment of the present invention, the antenna module comprises a first connecting part, a signal feed-in part, a ground part, a second connecting part, a third connecting part, a first radiation part, and a second radiation part. The signal feed-in part is extended from a first terminal of the first connecting part, and the extending direction of the signal feed-in part is perpendicular to the extending direction of the first connecting part. The ground part is extended from a second terminal of the first connecting part. The second connecting part is connected to the outer side of the first connecting part and the signal feed-in part and has a first side and a second side, and the first side is parallel to the second side. The second connecting part is perpendicularly connected to the outer side of the signal feed-in part through the first side. The third connecting part is connected to the outer side of the first connecting part and the ground part and has a third side and a fourth side, and the third side is parallel to the fourth side. The third connecting part is perpendicularly connected to the outer side of the ground part through the third side. The first radiation part is perpendicularly connected to the second side and parallel to but not overlapping the first connecting part, the signal feed-in part, and the ground part. The second radiation part is perpendicularly connected to the fourth side. The signal feed-in part, the second connecting part, and the first radiation part are for providing the antenna module with a current path of a first resonance frequency band, and the signal feed-in part, the first connecting part, the third connecting part, and the second radiation part are for providing the antenna module with a current path of a second resonance frequency band.

In an embodiment, the length of the outer side of the signal feed-in part is greater than the length of the first side and the length of the outer side of the ground part is greater than the length of the third side.

In an embodiment, the first resonance frequency band partially overlaps the second resonance frequency band.

In an embodiment, the first radiation part comprises a first sub radiation part, a second sub radiation part, and a third sub radiation part, and the first sub radiation part and the second sub radiation part are extended from the two opposite terminals of the inner side of the third sub radiation part, and the first sub radiation part is parallel to the second sub radiation part, and the first sub radiation part is connected to part of the second side.

According to a wireless transceiver device of an embodiment of the present invention, the wireless transceiver device is for electrically connecting with a host device and transferring data by transmitting and receiving wireless signals. The wireless transceiver device comprises a case, a transmission interface, and an antenna module, wherein the transmission interface is exposed outside the case for electrically connecting with the host device. The antenna module is installed inside the case and comprises a first connecting part, a signal feed-in part, a ground part, a second connecting part, a third connecting part, a first radiation part, and a second radiation part. The signal feed-in part is extended from a first terminal of the first connecting part, and the extending direction of the signal feed-in part is perpendicular to the extending direction of the first connecting part, and a terminal of the signal feed-in part which departs from the first connecting part is connected to the transmission interface. The ground part is extended from a second terminal of the first connecting part, and a terminal of the ground part which departs from the first connecting part is connected to the transmission interface. The second connecting part is connected to the outer side of the first connecting part and the signal feed-in part, and has a first side and a second side, and the first side is parallel to the second side. The second connecting part is perpendicularly connected to the outer side of the signal feed-in part through the first side. The third connecting part is connected to the outer side of the first connecting part and the ground part, and has a third side and a fourth side, and the third side is parallel to the fourth side. The third connecting part is perpendicularly connected to the outer side of the ground part through the third side. The first radiation part is perpendicularly connected to the second side and parallel to but not overlapping the first connecting part, the signal feed-in part, and the ground part. The second radiation part is perpendicularly connected to the fourth side. The signal feed-in part, the second connecting part, and the first radiation part are for providing the antenna module with a current path of a first resonance frequency band, and the signal feed-in part, the first connecting part, the third connecting part, and the second radiation part are for providing the antenna module with a current path of a second resonance frequency band.

In an embodiment, the length of the outer side of the signal feed-in part is greater than the length of the first side and the length of the outer side of the ground part is greater than the length of the third side.

In an embodiment, the first resonance frequency band partially overlaps the second resonance frequency band.

In an embodiment, the first radiation part comprises a first sub radiation part, a second sub radiation part, and a third sub radiation part, and the first sub radiation part and the second sub radiation part are extended from the two opposite terminals of the inner side of the third sub radiation part, and the first sub radiation part is parallel to the second sub radiation part, and the first sub radiation part is connected to part of the second side.

In an embodiment, the transmission interface is universal serial bus (USB).

In summary, the present invention provides a wireless transceiver device and an antenna module thereof, and the antenna module can have a current path of a first resonance frequency band and a current path of a second resonance frequency band through the structural design. The first resonance frequency band partially overlaps the second resonance frequency band, so that the antenna module can have a larger working frequency band and form a single band antenna.

The contents of the present invention set forth and the embodiments hereinafter are for demonstrating and illustrating the spirit and principles of the present invention, and for providing further explanation of the claims.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a 3D diagram of a wireless transceiver device according to an embodiment of the present invention.

FIG. 2 is a 3D diagram of an antenna module according to FIG. 1.

FIG. 3 is an expanded plane diagram of an antenna module according to FIG. 1.

FIG. 4A is a return loss measurement result of an antenna module of a wireless transceiver device according to an embodiment of the present invention.

FIG. 4B is a standing wave ratio measurement result of an antenna module of a wireless transceiver device according to an embodiment of the present invention.

FIG. 4C is a Smith chart of an antenna module of a wireless transceiver device according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

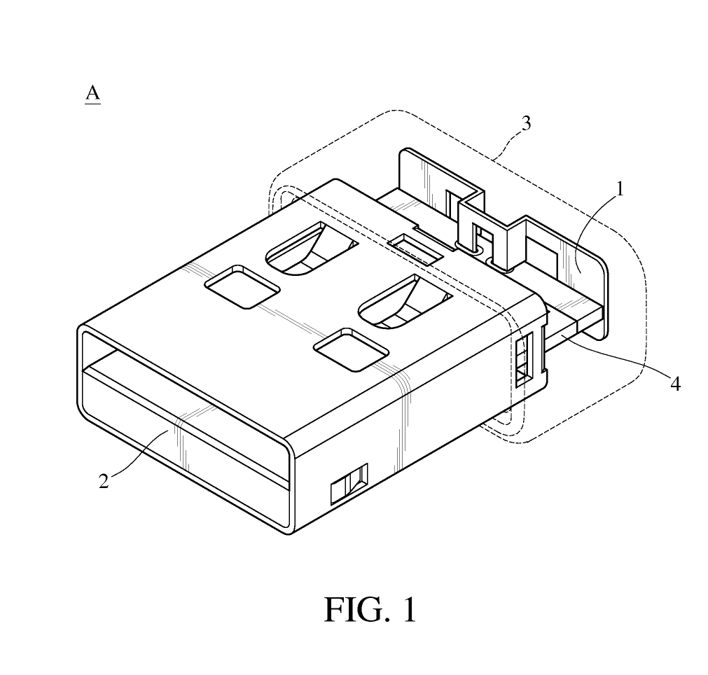

Please refer to FIG. 1. FIG. 1 is a 3D diagram of a wireless transceiver device according to an embodiment of the present invention. As shown in FIG. 1, a wireless transceiver device A is for electrically connecting with a host device, which is not illustrated in the figure, and transferring data by transmitting and receiving wireless signals. In other words, the host device can be communication connected with other host device through the wireless transceiver device A, and transfer the data in the host device to other host device or receive the data from other host device wirelessly. In practice, the host device includes but not limited to a desktop computer, a laptop, or a tablet.

The wireless transceiver device A mainly includes an antenna module 1, a transmission interface 2, a case 3, and a substrate 4, wherein the transmission interface 2 is exposed outside the case 3, and the antenna module 1 is installed inside the case 3. The transmission interface 2 is for electrically connecting with a data transmission interface of the host device to transfer data. In an embodiment of the present invention, the transmission interface 2 is a universal serial bus (USB) port, and the USB port includes a power pin, a first data pin, a second data pin, and a ground pin. When the transmission interface 2 of the wireless transceiver device A is electrically connected with the host device, the wireless transceiver device A obtains the system voltage and the ground potential from the power supply of the host device through the power pin (VBUS) and the ground pin (GND) and transfers data to the host device through the first data pin and the second data pin.

The wireless transceiver device A can further include a processing module. The processing module is disposed on the substrate 4 and electrically connected between the transmission interface 2 and the antenna module 1 for encoding/decoding the transmitted/received data. In addition, although the transmission interface 2 in FIG. 1 is a USB port, however, the transmission interface 2 can also be a PS/2 interface, a RS-232 interface, a IEEE 1394 interface, also called firewire interface, or a game controller port. The present invention does not have any limitation. In practice, the distance between the antenna module 1 and the case 3 is only approximate to 1 millimeter, and the present invention does not have any limitation on the distance. In addition, the material of the case 3 can be plastic or other insulation material. The present invention does not have any limitation. In order to clearly explain the detailed structure of the antenna module 1, the following describes each part of the antenna module 1 specifically.

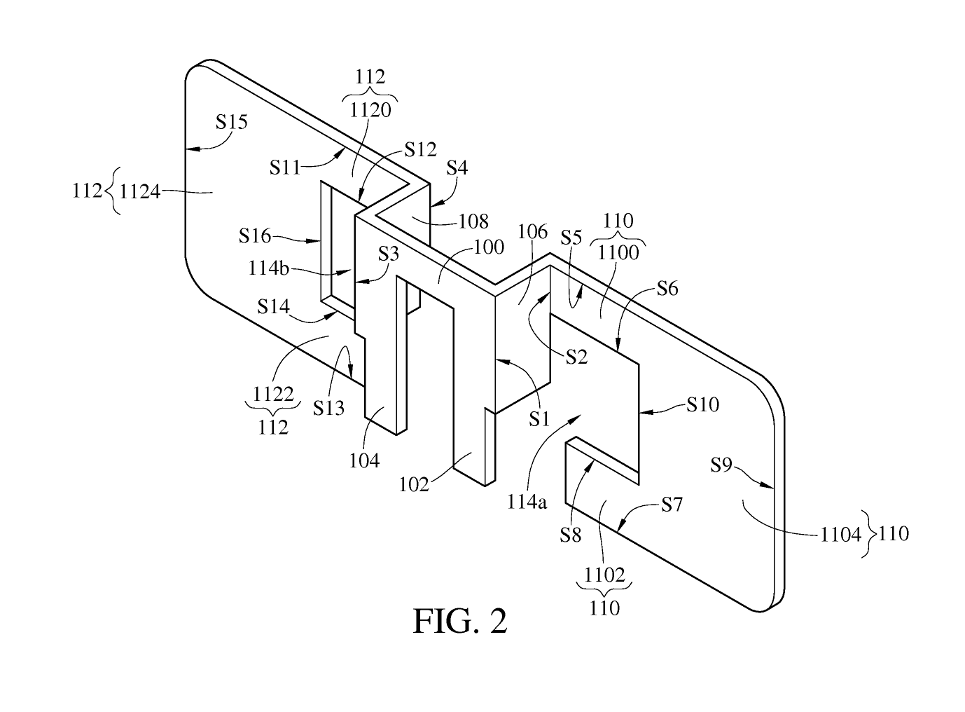

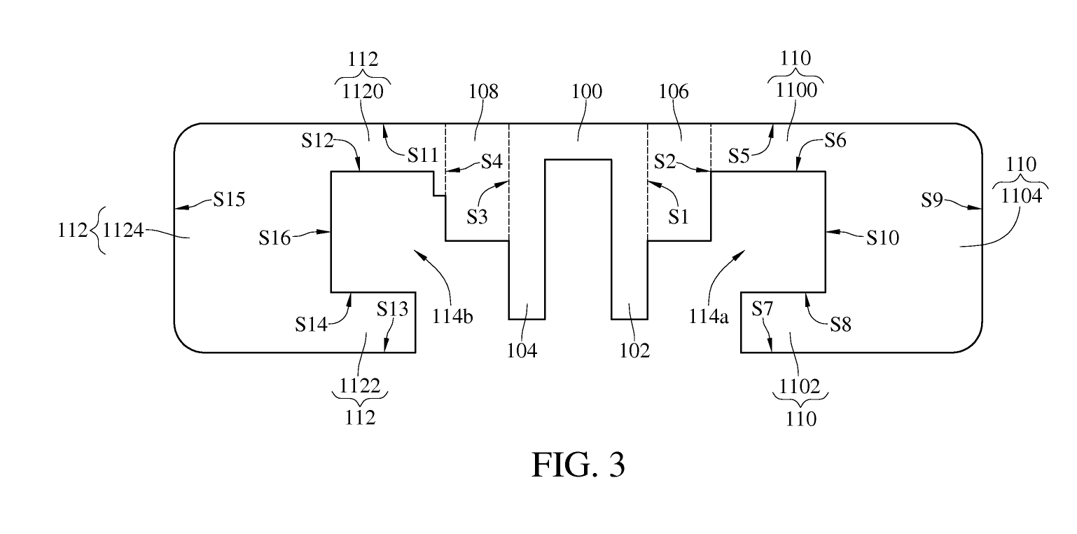

Please refer to FIG. 2 and FIG. 3 together. FIG. 2 is a 3D diagram of an antenna module according to FIG. 1. FIG. 2 is an expanded plane diagram of an antenna module according to FIG. 1. As shown in FIG. 2 and FIG. 3, the antenna module 1 is made of a flexibly conductive material, and the antenna module 1 is flexibly disposed inside the case 3 of the wireless transceiver device A, which forms a three dimensional structure. In other words, the antenna module 1 is integrally formed. The antenna module 1 mainly includes a first connecting part 100, a signal feed-in part 102, a ground part 104, a second connecting part 106, a third connecting part 108, a first radiation part 110, and a second radiation part 112. In addition, the present invention does not limit the conductive material for making the antenna module 1, and the available conductive material can be copper, aluminum, or any other flexibly conductive material.

The signal feed-in part 102 is extended from a first terminal of the first connecting part 100, and the extending direction of the signal feed-in part 102 is perpendicular to the extending direction of the first connecting part 100. The ground part 104 is extended from a second terminal of the first connecting part 100, and the extending direction of the ground part 104 is perpendicular to the extending direction of the first connecting part 100. In other words, the first connecting part 100 is connected between the signal feed-in part 102 and the ground part 104, and the signal feed-in part 102, the ground part 104, and the first connecting part 100 are located in the same plane to form a U shape. In an embodiment of the present invention, a terminal of the signal feed-in part 102 which departs from the first connecting part 100 has a signal feed-in point, which is not illustrated in the figure, and a terminal of the ground part 104 which departs from the first connecting part 100 has a ground point, which is not illustrated in the figure. The signal feed-in point and the ground point are respectively connected with the transmission interface 2, and the signal feed-in point is for feeding-in signal to the antenna module 1.

The second connecting part 106 is connected to the outer side of the first connecting part 100 and the signal feed-in part 102, and has a first side S1 and a second side S2, and the first side S1 is parallel to the second side S2, and the second connecting part 106 is perpendicularly connected to the outer side of the signal feed-in part 102 through the first side S1. In other words, the second connecting part 106 is extended from the outer side of the signal feed-in part 102 close to the first connecting part 100. The third connecting part 108 is connected to the outer side of the ground part 104 and the first connecting part 100, so the third connecting part 108 has a third side S3 and a fourth side S4, and the third side S3 is parallel to the fourth side S4, and the third connecting part 108 is perpendicularly connected to the outer side of the ground part 104 through the third side S3. In other words, the third connecting part 108 is extended from the outer side of the ground part 104 close to the first connecting part 100.

In other words, the second connecting part 106 and the third connecting part 108 are respectively extended from the outer side of the signal feed-in part 102 and the outer side of the ground part 104, and the second connecting part 106 and the third connecting part 108 are perpendicular to the plane formed by the signal feed-in part 102, the ground part 104, and the first connecting part 100, so that the angle between the second connecting part 106 and the signal feed-in part 102 and the angle between the third connecting part 108 and the ground part 104 are 90 degree. Specifically, the length of the outer side of the signal feed-in part 102 is greater than the length of the first side S1 of the second connecting part 106, and the length of the outer side of the ground part 104 is greater than the length of the third side S3 of the third connecting part 108. In other words, the first side S1 of the second connecting part 106 is only connected to part of the outer side of the signal feed-in part 102, and the third side S3 of the third connecting part 108 is only connected to part of the outer side of the ground part 104.

The first radiation part 110 is perpendicularly connected to the second side S2 of the second connecting part 106, and parallel to but not overlapping the first connecting part 100, the signal feed-in part 102, and the ground part 104. The second radiation part 112 is perpendicularly connected to the fourth side S4 of the third connecting part 108, which means the second radiation part 112 is parallel to but not overlapping the plane formed by the first connecting part 100, the signal feed-in part 102, and the ground part 104. In other words, the angle between the first radiation part 110 and the second connecting part 106 and the angle between the second radiation part 112 and the third connecting part 108 are 90 degree, and the first radiation part 110 and the second radiation part 112 departs from the first connecting part 100. In practice, a gap is between the first radiation part 110/second radiation part 112 and the substrate 4. In other words, the first radiation part 110 and the second radiation part 112 do not touch the substrate 4.

Specifically, the structure of the first radiation part 110 and the second radiation part 112 are in a U shape. The first radiation part 110 has a gap 114a and the second radiation part 112 has a gap 114b. The directions of the gap 114a and the gap 114b are towards the first connecting part 100. Therefore, the first radiation part 110 can further include a first sub radiation part 1100, a second sub radiation part 1102, and a third sub radiation part 1104, wherein the first sub radiation part 1100 and the second sub radiation part 1102 are respectively extended from the two opposite terminals of the inner side S10 of the third sub radiation part 1104, and the first sub radiation part 1100 is parallel to the second sub radiation part 1102. The first sub radiation part 1100 is connected to part of the second side S2. Similarly, the second radiation part 112 can further include a fourth sub radiation part 1120, a fifth sub radiation part 1122, and a sixth sub radiation part 1124, wherein the fourth sub radiation part 1120 and the fifth sub radiation part 1122 are respectively extended from the two opposite terminals of the inner side S16 of the sixth sub radiation part 1124, and the fourth sub radiation part 1120 is parallel to the fifth sub radiation part 1122. The fourth sub radiation part 1120 is connected to part of the fourth side S4.

The gap 114a is surrounded by the inner side S6 of the first sub radiation part 1100, the inner side S10 of the third sub radiation part 1104, and the inner side S8 of the second sub radiation part 1102 surrounding. The gap 114b is surrounded by the inner side S12 of the fourth sub radiation part 1120, the inner side S16 of the sixth sub radiation part 1124, and the inner side S14 of the fifth sub radiation part 1122.

In an embodiment of the present invention, the distance between the outer side S9 and the inner side S10 of the third sub radiation part 1104 is greater than the distance between the outer side S5 and the inner side S6 of the first sub radiation part 1100, and greater than the distance between the outer side S7 and the inner side S8 of the second sub radiation part 1102. The distance between the outer side S15 and the inner side S16 of the sixth sub radiation part 1124 is greater than the distance between the outer side S11 and the inner side S12 of the fourth sub radiation part 1120, and greater than the distance between the outer side S13 and the inner side S14 of the fifth sub radiation part 1122.

In practice, the signal feed-in part 102, the second connecting part 106, and the first radiation part 110 are for providing the antenna module 1 with a current path of a first resonance frequency band, which is not illustrated in the figure, and the signal feed-in part 102, the first connecting part 100, the third connecting part 108, and the second radiation part 112 are for providing the antenna module 1 with a current path of a second resonance frequency band, which is not illustrated in the figure. Because the length of the current path determines the range of the working frequency band of the antenna module 1, the second resonance frequency band is slightly higher than the first resonance frequency band. It is worth mentioning that the first resonance frequency band partially overlaps the second resonance frequency band, so that the antenna module 1 can have a larger working frequency band and forms a single band antenna. In other words, the antenna module 1 of the present invention applies the dual band concept and the design of the antenna structure to increase the bandwidth of the antenna module 1 and form a single band antenna. In practice, the increased bandwidth percentage of the antenna module 1 is greater than 20%.

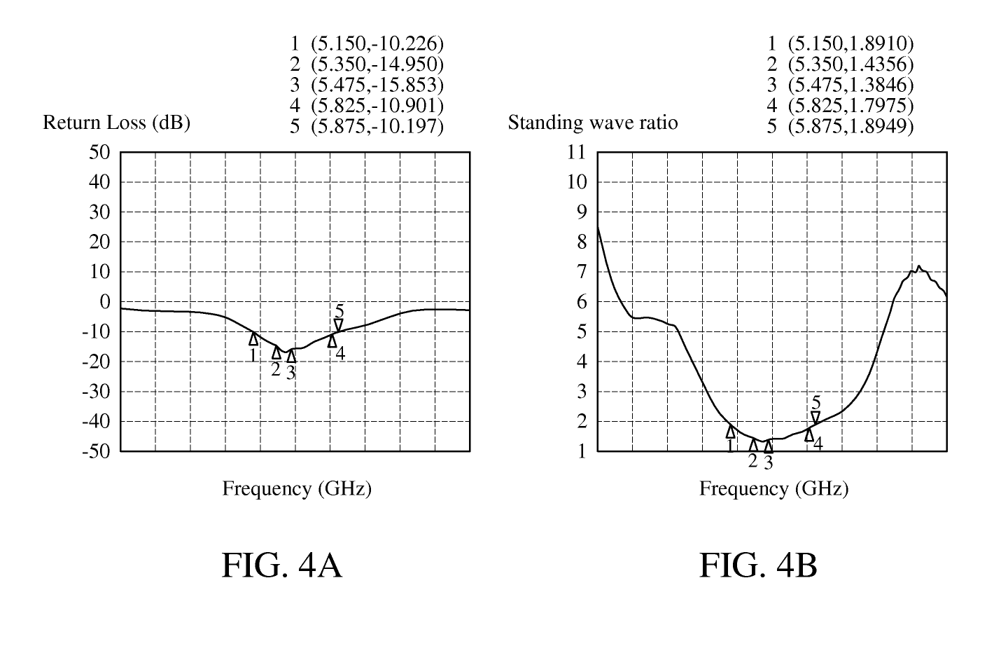

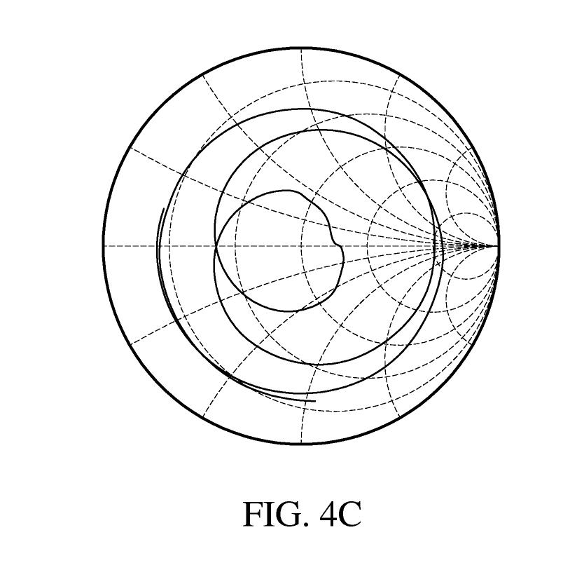

Please refer to FIG. 4A, FIG. 4B, and FIG. 4C. FIG. 4A is a return loss measurement result of an antenna module of a wireless transceiver device according to an embodiment of the present invention. FIG. 4B is a standing wave ratio measurement result of an antenna module of a wireless transceiver device according to an embodiment of the present invention. FIG. 4C is a Smith chart of an antenna module of a wireless transceiver device according to an embodiment of the present invention. Return loss, standing wave ratio (SWR), and Smith chart are familiar to person skilled in the art and not further described hereinafter.

In addition, when the antenna module 1 of the present invention operates in 5.15 GHz, the average gain of the antenna module 1 is −1.53 dB, and the peak gain ratio is 4.81 dBi, and the efficiency is 70.21%. When the antenna module 1 operates in 5.35 GHz, the average gain of the antenna module 1 is −1.31 dB, and the peak gain ratio is 5.21 dBi, and the efficiency is 73.82%. When the antenna module 1 operates in 5.825 GHz, the average gain of the antenna module 1 is −1.22 dB, and the peak gain ratio is 5.82 dBi, and the efficiency is 75.44%. When the antenna module 1 operates in 5.875 GHz, the average gain of the antenna module 1 is −1.47 dB, and the peak gain ratio is 5.65 dBi, and the efficiency is 76.66%. In practice, the working frequency band of the antenna module 1 is approximate to 5.15 GHz˜5.875 GHz. In other words, the working frequency band formed by the overlapping of the first resonance frequency band and the second resonance frequency band is approximate to 5.15 GHz˜5.875 GHz. The present invention does not have any limitation.

In summary, the embodiment of the present invention provides a wireless transceiver device and an antenna module thereof, and the antenna module can have a current path of a first resonance frequency band and a current path of a second resonance frequency band through the structural design. The first resonance frequency band partially overlaps the second resonance frequency band, so that the antenna module can have a larger working frequency band and form a single band antenna. Therefore, the wireless transceiver device and the antenna module thereof solve the problem of impedance matching and reduce the manufacture difficulty and cost. The applicability is increased accordingly.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. An antenna module, comprising:
a first connecting part;
a signal feed-in part extended from a first terminal of the first connecting part, and the extending direction of the signal feed-in part perpendicular to an extending direction of the first connecting part;
a ground part extended from a second terminal of the first connecting part;
a second connecting part connected to the first connecting part and an outer side of the signal feed-in part, having a first side and a second side, the first side parallel to the second side, the second connecting part perpendicularly connected to the outer side of the signal feed-in part through the first side;
a third connecting part connected to the first connecting part and an outer side of the ground part, having a third side and a fourth side, the third side parallel to the fourth side, the third connecting part perpendicularly connected to the outer side of the ground part through the third side;
a first radiation part perpendicularly connected to the second side, and parallel to but not overlapping the first connecting part, the signal feed-in part, and the ground part; and
a second radiation part perpendicularly connecting to the fourth side;
wherein the signal feed-in part, the second connecting part, and the first radiation part are for providing the antenna module with a current path of a first resonance frequency band, and the signal feed-in part, the first connecting part, the third connecting part, and the second radiation part are for providing the antenna module with a current path of a second resonance frequency band.

2. The antenna module of claim 1, wherein the length of the outer side of the signal feed-in part is greater than the length of the first side and the length of the outer side of the ground part is greater than the length of the third side.

3. The antenna module of claim 1, wherein the first resonance frequency band partially overlaps the second resonance frequency band.

4. The antenna module of claim 1, wherein the first radiation part comprises a first sub radiation part, a second sub radiation part, and a third sub radiation part, and the first sub radiation part and the second sub radiation part are extended from the two opposite terminals of the inner side of the third sub radiation part, and the first sub radiation part is parallel to the second sub radiation part, and the first sub radiation part is connected to part of the second side.

5. A wireless transceiver device for electrically connecting with a host device and transferring data by transmitting and receiving wireless signals, the wireless transceiver device comprising:
a case;
a transmission interface exposed outside the case for electrically connecting with the host device; and
an antenna module installed inside the case, the antenna module comprising:
a first connecting part;
a signal feed-in part extended from a first terminal of the first connecting part, and the extending direction of the signal feed-in part perpendicular to the extending direction of the first connecting part, and a terminal of the signal feed-in part which departs from the first connecting part connected to the transmission interface;
a ground part extended from a second terminal of the first connecting part, a terminal of the ground part which departs from the first connecting part connected to the transmission interface;
a second connecting part connected to the outer side of the first connecting part and the signal feed-in part, having a first side and a second side, the first side parallel to the second side, the second connecting part perpendicularly connected to the outer side of the signal feed-in part through the first side;
a third connecting part connected to the outer side of the first connecting part and the ground part, having a third side and a fourth side, the third side parallel to the fourth side, the third connecting part perpendicularly connected to the outer side of the ground part through the third side;
a first radiation part perpendicularly connected to the second side, and parallel to but not overlapping the first connecting part, the signal feed-in part, and the ground part; and
a second radiation part perpendicularly connected to the fourth side;
wherein the signal feed-in part, the second connecting part, and the first radiation part are for providing the antenna module with a current path of a first resonance frequency band, and the signal feed-in part, the first connecting part, the third connecting part, and the second radiation part are for providing the antenna module with a current path of a second resonance frequency band.

6. The wireless transceiver device of claim 5, wherein the length of the outer side of the signal feed-in part is greater than the length of the first side and the length of the outer side of the ground part is greater than the length of the third side.

7. The wireless transceiver device of claim 5, wherein the first resonance frequency band partially overlaps the second resonance frequency band.

8. The wireless transceiver device of claim 5, wherein the first radiation part comprises a first sub radiation part, a second sub radiation part, and a third sub radiation part, and the first sub radiation part and the second sub radiation part are extended from the two opposite terminals of the inner side of the third sub radiation part, and the first sub radiation part is parallel to the second sub radiation part, and the first sub radiation part is connected to part of the second side.

9. The wireless transceiver device of claim 5, wherein the transmission interface is universal serial bus (USB).
